(19) United States
(12) Patent Application Publication
(10) Pub. No.: US 2006/0084756 A1
(43) Pub. Date: Apr. 20, 2006

(54) Low refractive index coating composition

(75) Inventors: John E. Southwell, Elgin, IL (US); Chander P. Chawla, Batavia, IL (US)

Correspondence Address: MAYER, BROWN, ROWE & MAW LLP, 1909 K STREET, N.W., WASHINGTON, DC, 20006, US

(73) Assignee: DSM IP Assets B.V., Heerlen (NL)

(21) Appl. No.: 11/110,886

(22) Filed: Apr. 21, 2005

Related U.S. Application Data
(60) Provisional application No. 60/578,902, filed on Jun. 14, 2004.
(60) Provisional application No. 60/580,137, filed on Jun. 17, 2004.
(60) Provisional application No. 60/564,294, filed on Apr. 22, 2004.

(51) Int. Cl. B32B 27/40; B32B 27/02; C08G 18/08

(52) U.S. Cl. 524/589; 428/421; 428/423.1; 428/323; 428/212

(57) ABSTRACT

Coating compositions are provided that, when cured, provide a coating with low refractive index, surface hardness, scratch resistance, abrasion resistance and good curability at low film thickness. In one embodiment, a composition is provided that comprises reactive nanoparticles free of fluorinated group, reactive nanoparticles having at least one fluorinated group, and an ethylenically unsaturated urethane fluorinated component.

### CROSS REFERENCE TO RELATED APPLICATIONS

This application claims the benefit of U.S. Provisional Ser. No. 60/578,902, filed Jun. 14, 2004, and U.S. Provisional Ser. No. 60/580,137, filed Jun. 17, 2004, and U.S. Provisional Ser. No. 60/564,294, filed Apr. 22, 2004. These applications, in their entirety, are incorporated herein by reference.

### FIELD OF THE INVENTION

The present invention relates to radiation curable compositions, to coatings formed by curing these compositions, to processes of preparation of such coatings and to articles comprising such coatings. An aspect of the invention concerns the application of such coating on the layers of hardcoat or display systems.

### BACKGROUND OF THE INVENTION

The art has seen various attempts in developing coating compositions, yet an interest remains in the development of coating composition used for preparing low refractive index coating layers with good surface hardness, scratch resistance, abrasion resistance and good curability at low film thickness. Objectives of the present invention include creating such coating compositions.

U.S. Pat. No. 6,391,459 discusses a radiation curable composition containing a fluorinated urethane oligomer. U.S. Pat. No. 6,160,067 mentions reactive silica particles with a polymerizable unsaturated group.

### SUMMARY OF THE INVENTION

Objectives of the present invention include providing compositions that, when cured, provide a coating with low refractive index, surface hardness, scratch resistance, abrasion resistance and/or good curability at low film thickness.

One embodiment of the composition of the present invention is a radiation curable composition, comprising:
reactive nanoparticles free of (or absent) fluorinated groups;
reactive nanoparticles having at least one fluorinated group; and
an ethylenically unsaturated urethane fluorinated component.

Another embodiment of the present invention is an article comprising:
a substrate;
a hardcoat layer;
a high refractive index coating on said hardcoat layer; and
a low refractive index coating, said low refractive index coating obtained by curing the composition comprising:
   i) reactive nanoparticles free of fluorinated groups;
   ii) reactive nanoparticles having at least one fluorinated group; and
   iii) an ethylenically unsaturated urethane fluorinated component.

Among other embodiments of the present invention, the process of making a coating from the compositions is provided. The compositions of the present invention are used to provide coating for various applications, for instance in optical fiber, photonics crystal fiber, ink and matrix, optical media, hard coat and/or display.

Another aspect of the invention concerns the use of the present compositions to form coatings on substrates including for example display monitors (like flat screen computer and/or television monitors such as those utilizing technology discussed in, for example, U.S. Pat. Nos. 6,091,184 and 6,087,730 which are both hereby incorporated by reference), optical discs, touch screens, smart cards, flexible glass and the like.

There is great interest in the development of plastic substrates for, for instance, LCD (liquid crystal display) and OLED (organic light emitting diode) display applications.

The present compositions may be used as coating compositions. For instance, the present compositions may be used to coat substrates. Suitable substrates to be coated include organic substrates. Organic substrates are preferably polymeric (“plastic”) substrates, such as substrates comprising polynorbornene, polyethyleneterephtalate, polymethylmethacrylate, polycarbonate, polyethersulphone, polyimide, fluorene polyester (e.g. a polymer consisting essentially of repeating interpolymerized units derived from 9,9-bis(4-hydroxyphenyl)fluorene and isophthalic acid, terephthalic acid or mixtures thereof), cellulose (e.g. triacetate cellulose), and/or polyethernaphtalene. Particularly preferred substrates include polynorbornene substrates, fluorene polyester substrates, triacetate cellulose substrates, and polyimide substrates.

Additional objects, advantages and features of the present invention are set forth in this specification, and in part will become apparent to those skilled in the art on examination of the following, or may be learned by practice of the invention. The inventions disclosed in this application are not limited to any particular set of or combination of objects, advantages and features. It is contemplated that various combinations of the stated objects, advantages and features make up the inventions disclosed in this application.

### DESCRIPTION OF THE INVENTION

### Definitions

“Nanoparticles” refers to a particle mixture wherein the majority of particles in the mixture have a dimension below 1 μm.

“Dimension of a nanoparticle” (or “size of a nanoparticle”) refers for spherical particles to the diameter of the particles. For non-spherical particles, it refers to the distance of the longest straight line drawn from one side of the nanoparticle to the opposite side.

“(Meth)acrylate” refers to “acrylate and/or methacrylate”.

“Reactive nanoparticle” refers to a nanoparticle having at least one reactive group (e.g., a polymerizable group).

The invention relates, inter alia, to a radiation curable composition comprising:
reactive nanoparticles absent a fluorinated group;
reactive nanoparticles having at least one fluorinated group; and
an ethylenically unsaturated urethane fluorinated component.
   Reactive Nanoparticles

The method of preparing reactive nanoparticles may vary. In one embodiment, reactive particles may comprise metal oxide nanoparticles (A) and chemically bound thereto a component (B), wherein component (B) comprises at least one reactive group, for instance a polymerizable group.

In one embodiment, metal oxide nanoparticles (A)include nanoparticles selected from the group consisting of oxides of silicon, aluminum, zirconium, titanium, zinc, germanium, indium, tin, antimony, and cerium. In one embodiment, nanoparticles (A) are a single metal oxide. In another embodiment, nanoparticles (A) are a mixture of different metal oxides. It will be understood by those skilled in the art that, for purposes of the present invention, the metal oxide nanoparticles of the present invention include oxide of silicon, even though silicon may not be viewed as a “metal” in normal usage.

Metal oxide nanoparticles (A) may be used, for instance, in the form of a powder or in the form of a water or solvent dispersion (sol). When the metal oxide nanoparticles are in the form of a dispersion, an organic solvent is preferable as a dispersion medium from the viewpoint of mutual solubility with other components and dispersibility. Use of a solvent dispersion of metal oxide is particularly desirable in the application in which excellent transparency of cured products is required. Examples of organic solvents include alcohols such as for example methanol, ethanol, isopropanol, butanol, and octanol; ketones such as acetone, methyl ethyl ketone, methyl isobutyl ketone, and cyclohexanone; esters such as for example ethyl acetate, butyl acetate, ethyl lactate, and γ-butyrolactone, propylene glycol monomethyl ether acetate, and propylene glycol monoethyl ether acetate; ethers such as for example ethylene glycol monomethyl ether and diethylene glycol monobutyl ether; aromatic hydrocarbons such as for example benzene, toluene, and xylene; and amides such as for example dimethylformamide, dimethylacetamide, and N-methylpyrrolidone.

In one embodiment, nanoparticles (A) include colloidal silicon oxide nanoparticles. Such silica nanoparticles are available, for instance, under the trade names Methanol Silica Sol, IPA-ST, MEK-ST, NBA-ST, XBA-ST, DMAC-ST, ST-UP, ST-OUP, ST-20, ST-40, ST-C, ST-N, ST-O, ST-50, ST-OL, etc. manufactured by Nissan Chemical Industries, Ltd. Examples of powdery silica include products available under the trade names AEROSIL 130, AEROSIL 300, AEROSIL 380, AEROSIL TT600, and AEROSIL OX50 (manufactured by Japan Aerosil Co., Ltd.), Sildex H31, H32, H51, H52, H121, H122 (manufactured by Asahi Glass Co., Ltd.), E220A, E220 (manufactured by Nippon Silica Industrial Co., Ltd.), SYLYSIA470 (manufactured by Fuji Silycia Chemical Co., Ltd.) and SG Flake (manufactured by Nippon Sheet Glass Co., Ltd.).

Examples of commercially available dispersions of alumina include aqueous dispersions Alumina Sol-100,-200,-520 (trade names, manufactured by Nissan Chemical Industries, Ltd.); isopropanol dispersions of alumina, AS-150I (trade name, manufactured by Sumitomo Osaka Cement Co., Ltd.); and toluene dispersion of alumina, AS-150T (trade name, manufactured by Sumitomo Osaka Cement Co., Ltd.). An example of a toluene dispersion of zirconia is HXU-110JC (trade name, manufactured by Sumitomo Osaka Cement Co., Ltd.). An example of an aqueous dispersion product of zinc antimonate powder is Celnax (trade name, manufactured by Nissan Chemical Industries, Ltd.). Examples of powders and solvent dispersion products of alumina, titanium oxide, tin oxide, indium oxide, zinc oxide are available under the name, Nano Tek, for example, (trade name, manufactured by CI Kasei Co., Ltd.). An example of an aqueous dispersion sol of antimony dope-tin oxide is SN-100D (trade name, manufactured by Ishihara Sangyo Kaisha, Ltd.). An example of an ITO powder is a product manufactured by Mitsubishi Material Co., Ltd.; and an example of an aqueous dispersion of cerium oxide is Needral (trade name, manufactured by Taki Chemical Co., Ltd.).

The shape of metal oxide nanoparticles (A) may be of a shape suitable for the desired application including spherical, non-spherical, hollow, porous, rod-like, plate-like, fibrous, amorphous and/or combinations of these. For example, the nanoparticles may be rod-like and hollow, or plate-like and porous, etc.

In one embodiment, the plurality (for instance at least 60%, at least 75%, at least 90%, at least 94%, at least 96%, or at least 98%) of nanoparticles (A) has a size below 900 nm, e.g. below 750 nm, below 600 nm, below 500 nm, below 300 nm, or below 150 nm, below 100 nm, or even below 75 nm. In one embodiment, the plurality (for instance at least 60%, at least 75%, at least 90%, at least 94%, at least 96%, or at least 98%) of nanoparticles (A) has a size of at least 0.1 nm, e.g. at least 1 nm, at least 5 nm, at least 10 nm, or at least 20 nm. Processes for determining the particle size include, e.g., BET adsorption, optical or scanning electron microscopy, or atomic force microscopy (AFM) imaging.

In one embodiment, the average size of nanoparticles (A) is below 900 nm, e.g. below 750 nm, below 600 nm, below 500 nm, below 300 nm, or below 150 nm, below 100 nm, or even below 75 nm. In one embodiment, the average size of nanoparticles (A) is at least 0.1 nm, e.g. at least 1 nm, at least 5 nm, at least 10 nm, or at least 20 nm.

Component (B) may be, for instance, an organic component and/or inorganic-organic component comprising a reactive group. Examples of reactive groups contained in the component (B) include, e.g., ethylenically unsaturated groups, such as (meth)acrylate or vinyl ether groups.

In one embodiment, component (B) also includes one or more groups represented by the following formula (1):

—X—C(═Y)—NH— (1)

wherein X represents NH, O (oxygen atom), or S (sulfur atom), and Y represents O or S.

The group represented by the formula (1) is, for instance, a urethane bond [—O—C(═O)—NH—], —O—C(═S)—NH—, or a thiourethane bond [—S—C(═O)—NH—].

Also, in one embodiment component (B) includes a silanol group or a group which forms a silanol group by hydrolysis.

Examples of component (B) include, for instance, alkoxysilane components which include a urethane bond [—O—C(═O)NH—] and/or a thiourethane bond [—S—C(═O)NH—] and at least two polymerizable unsaturated groups in the molecule.

A particular example of a component (B) suitable for reaction with nanoparticles (A) is represented by the following structure Formula I:

### Formula I

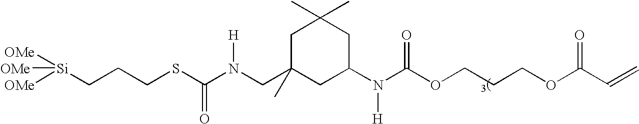

Another example is, for instance, a component shown by the following formula (2): 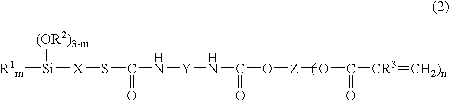
wherein R¹ represents a methyl group, R² represents an alkyl group having 1-6 carbon atoms, R³ represents a hydrogen atom or a methyl group, m represents either 1 or 2, n represents an integer of 1-5, X represents a divalent alkylene group having 1-6 carbon atoms, Y represents a linear, cyclic, or branched divalent hydrocarbon group having 3-14 carbon atoms, Z represents a linear, cyclic, or branched divalent hydrocarbon group having 2-14 carbon atoms. Z may include an ether bond.

The component shown by the formula (2) may be prepared, for instance, by reacting a mercaptoalkoxysilane, a diisocyanate, and a hydroxyl group-containing polyfunctional (meth)acrylate.

An example of a preparation method is, for instance, to react a mercaptoalkoxysilane with a diisocyanate to obtain an intermediate containing a thiourethane bond, and reacting the residual isocyanate with a hydroxyl group-containing polyfunctional (meth)acrylate to obtain a product containing a urethane bond.

The same product may be obtained by reacting a diisocyanate with a hydroxyl group-containing polyfunctional (meth)acrylate to obtain an intermediate containing a urethane bond, and reacting the residual isocyanate with a mercaptoalkoxysilane. However, since this method causes the addition reaction of the mercaptoalkoxysilane and the (meth)acrylic group to occur, purity of the product might suffer. Moreover, a gel may be formed.

As examples of the mercaptoalkoxysilane used to produce the component shown by the formula (2), γ-mercaptopropyltrimethoxysilane, γ-mercaptopropyltriethoxysilane, γ-mercaptopropyltributoxysilane, γ-mercaptopropyidimethylmethoxysilane, γ-mercaptopropylmethyldimethoxysilane, and the like can be given. Of these, γ-mercaptopropyltrimethoxysilane and γ-mercaptopropylmethyldimethoxysilane are preferable.

As examples of commercially available products of the mercaptoalkoxysilane, SH6062 (manufactured by Toray-Dow Corning Silicone Co., Ltd.) can be given.

As examples of diisocyanates, 1,4-butylene diisocyanate, 1,6-hexylene diisocyanate, isophorone diisocyanate, hydrogenated xylylene diisocyanate, hydrogenated bisphenol A diisocyanate, 2,4-toluene diisocyanate, 2,6-toluene diisocyanate, and the like can be given. Of these, 2,4-toluene diisocyanate, isophorone diisocyanate, and hydrogenated xylylene diisocyanate are preferable.

As examples of commercially available products of polyisocyanate compounds, TDI-80/20, TDI-100, MDI-CR100, MDI-CR300, MDI-PH, NDI (manufactured by Mitsui Nisso Urethane Co., Ltd.), Coronate T, Millionate MT, Millionate MR, HDI (manufactured by Nippon Polyurethane Industry Co., Ltd.), Takenate 600 (manufactured by Takeda Chemical Industries, Ltd.), and the like can be given.

As examples of hydroxyl group-containing polyfunctional (meth)acrylates, trimethylolpropane di(meth)acrylate, tris(2-hydroxyethyl)isocyanurate di(meth)acrylate, pentaerythritol tri(meth)acrylate, dipentaerythritol penta(meth)acrylate, and the like can be given. Of these, tris(2-hydroxyethyl)isocyanurate di(meth)acrylate, pentaerythritol tri(meth)acrylate, and dipentaerythritol penta(meth)acrylate are preferable. These compounds form at least two polymerizable unsaturated groups in the compound shown by the formula (2).

The mercaptoalkoxysilane, diisocyanate, and hydroxyl group-containing polyfunctional (meth)acrylate may be used either individually or in combination of two or more.

In the preparation of the component shown by the formula (2), the mercaptoalkoxysilane, diisocyanate, and hydroxyl group-containing polyfunctional (meth)acrylate are used so that the molar ratio of the diisocyanate to the mercaptoalkoxysilane is preferably 0.8-1.5, and still more preferably 1.0-1.2. If the molar ratio is less than 0.8, storage stability of the composition may be decreased. If the molar ratio exceeds 1.5, dispersibility may be decreased.

It is preferable to prepare the component shown by the formula (2) in dry air in order to prevent anaerobic polymerization of the acrylic group and hydrolysis of the alkoxysilane. The reaction temperature is preferably 0-100° C., and still more preferably 20-80° C.

In the preparation of the component shown by the formula (2), a conventional catalyst may be used in the urethanization reaction in order to reduce the preparation time. As the catalyst, dibutyltin dilaurate, dioctyltin dilaurate, dibutyltin di(2-ethylhexanoate), and octyltin triacetate can be given. In one embodiment, the catalyst is added in an amount of 0.01-1 wt % for the total amount of the catalyst and the diisocyanate.

A heat polymerization inhibitor may be added in the preparation in order to prevent heat polymerization of the compound shown by the formula (2). As examples of heat polymerization inhibitors, p-methoxyphenol, hydroquinone, and the like can be given. The heat polymerization inhibitor is added in an amount of preferably 0.01-1 wt % for the total amount of the heat polymerization inhibitor and the hydroxyl group-containing polyfunctional (meth)acrylate.

The component shown by the formula (2) may be prepared in a solvent. As the solvent, any solvent which does not react with mercaptoalkoxysilane, diisocyanate, and hydroxyl group-containing polyfunctional (meth)acrylate, and has a boiling point of 200° C. or less may be appropriately selected.

As specific examples of such a solvent, ketones such as methyl ethyl ketone, methyl isobutyl ketone, and cyclohexanone, esters such as ethyl acetate, butyl acetate, and amyl acetate, hydrocarbons such as toluene and xylene, and the like can be given.

As specific examples of alkoxysilane components, components having an unsaturated double bond in the molecule such as γ-methacryloxypropyltrimethoxysilane, γ-acryloxypropyltrimethoxysilane, and vinyltrimethoxysilane; components having an epoxy group in the molecule such as γ-glycidoxypropyltriethoxysilane and γ-glycidoxypropyltrimethoxysilane; compounds having an amino group in the molecule such as γ-aminopropyltriethoxysilane and γ-aminopropyltrimethoxysilane; components having a mercapto group in the molecule such as γ-mercaptopropyltrimethoxysilane and γ-mercaptopropyltriethoxysilane; alkylsilanes such as methyltrimethoxysilane, methyltriethoxysilane, and phenyltrimethoxysilane; and the like can be given. Of these, γ-mercaptopropyltrimethoxysilane, γ-glycidoxypropyltrimethoxysilane, methyltrimethoxysilane, methyltriethoxysilane, and phenyltrimethoxysilane are preferable from the viewpoint of dispersion stability of the surface-treated oxide particles.

The reactive group in the component (B) may vary. Reactive groups include, as mentioned before, for instance, unsaturated polymerizable groups. Reactive groups include, e.g., acrylate, methacrylate, propenyl, vinyl, butadienyl, styryl, ethynyl, cinnamoyl, vinyl ether, maleate, acrylamide, epoxy, oxetane, amine-ene, and thiol-ene groups.

The reactive group(s) in component (B) may also be a group that is polymerizable in combination with other groups. Examples of such combinations include, for instance, carboxylic acids and/or carboxylic anhydrides combined with epoxies, acids combined with hydroxy compounds, especially 2-hydroxyalkylamides, amines combined with isocyanates, for example blocked isocyanate, uretdion or carbodiimide, epoxies combined with amines or with dicyandiamides, hydrazinamides combined with isocyanates, hydroxy compounds combined with isocyanates, for example blocked isocyanate, uretdion or carbodiimide, hydroxy compounds combined with anhydrides, hydroxy compounds combined with (etherified) methylolamide (“amino-resins”), thiols combined with isocyanates, thiols combined with acrylates (optionally radical initiated), acetoacetate combined with acrylates, and when cationic crosslinking is used, epoxy compounds with epoxy or hydroxy compounds. Accordingly, for instance, part of components (B) may have an amine group as reactive group and another part of components (B) may have an isocyanate group as reactive group to form a polymerizable combination.

Further reactive groups that may be used include moisture curable isocyanates, moisture curable mixtures of alkoxy/acyloxy-silanes, alkoxy titanates, alkoxy zirconates, or urea-, urea/melamine-, melamine-formaldehyde or phenol-formaldehyde (resol, novolac types), or radical curable (peroxide- or photo-initiated) ethylenically unsaturated mono- and polyfunctional monomers and polymers, e.g. acrylates, methacrylates, maleate/vinyl ether), or radical curable (peroxide- or photo-initiated) unsaturated e.g. maleic or fumaric, polyesters in styrene and/or in methacrylates.

Regarding an example of a method to prepare reactive particles, suitable examples for reactive nanoparticles and their preparation are, for instance, set forth in U.S. Pat. No. 6,160,067 to Eriyama et al. and WO 00/4766, which are both hereby incorporated in their entirety by reference. Also, metal oxide nanoparticles (A) often have moisture on the surface of nanoparticles as adsorption water under usual storage conditions. In addition, components which react with a silanol group-forming component such as a hydroxide, hydrate, or the like are often present at least on the surface of the oxide nanoparticles. Therefore, the crosslinkable reactive nanoparticles may be produced by mixing a silanol group-forming component and oxide particles (A), and heating the mixture while stirring. It is desirable that the reaction is carried out in the presence of water to efficiently bind the silanol group-forming site possessed by the organic component (B) and the oxide nanoparticle (A).

Preferably, a dehydrating agent is added to promote the reaction. As a dehydrating agent, inorganic compounds such as zeolite, anhydrous silica, and anhydrous alumina, and organic compounds such as methyl orthoformate, ethyl orthoformate, tetraethoxymethane, and tetrabutoxymethane can be used. Organic compounds are usually used as dehydrating agents; examples are ortho esters such as methyl orthoformate and ethyl orthoformate.

Also, methods for preparing reactive nanoparticles absent a fluorinated group and reactive nanoparticles having at least one fluorinated group are presented in the “Examples” section infra.

In one embodiment, the reactive nanoparticles comprise, in addition to one or more components (B) having a reactive group, also one or more organic components not having a reactive group.

Reactive Nanoparticles Absent a Fluorinated Group and Reactive Nanoparticles Having at Least one Fluorinated Group:

“Reactive nanoparticles absent a fluorinated group” (or: “reactive nanoparticles free of a fluorinated group”) means that the components chemically bound to metal oxide nanoparticles do not contain any fluorinated group. “Reactive nanoparticles having at least one fluorinated group” is defined as reactive nanoparticles that are also bonded by components containing a fluorinated group, apart from the optional additional presence of components free of fluorinated groups. These fluorinated-containing components can either contain a reactive group or not. In other words, the fluorinated group is either located in the component that contains a reactive group, or is not located in the component that contains a reactive group. One example of a fluorinated-containing component without reactive group is for instance a trimethoxy silane species with a fluoroalkyl molecular component. Examples include, for instance, perfluorohexyl ethyl trimethoxysilane, perfluorooctyl ethyl trimethoxysilane, tridecafluoro-1,1,2,2-tetrahydrooctyl triethoxy silane, heptadecafluoro-1,1,2,2,tetra hydrodecyl triethoxy silane, or perfluorodecyl ethyl trimethoxysilane.

Examples of fluorinated groups include but are not limited to: difluoromethyl, trifluoromethyl, difluoroethyl, trifluoroethyl, tetrafluoroethyl, pentafluoroethyl, difluoropropyl, trifluoropropyl, tetrafluoropropyl, pentafluoropropyl, hexafluoropropyl, heptafluoropropyl, difluorobutyl, trifluorobutyl, tetrafluorobutyl, pentafluorobutyl, hexafluorobutyl, heptafluorobutyl, octafluorobutyl, difluoropentyl, trifluoropentyl, tetrafluoropentyl, pentafluoropentyl, hexafluoropentyl, heptafluoropentyl, octafluoropentyl, similarly perfluoro derivatives of C₁-C₃₀ branched or linear alkanes or alcohols and 1,1,2,2-tetrahydro fluoro derivatives of C₁-C₃₀ branched or linear alkanes or alcohols as well as partially ethoxylated or propoxylated versions of the aforementioned fluorinated alkanes/alcohols or 1,1,2,2-tetrahydro fluoro alkanes/alcohols. In one embodiment, the reactive particles having a fluorinated group include a fluoroalkyl groups.

In one embodiment of the present invention, the weight ratio of reactive nanoparticles absent a fluorinated group to reactive nanoparticles having at least one fluorinated group is from 1:10 to 20:1, for instance 1:9 to 9:1, 1:1 to 15:1, 3:1 to 10:1, 3:1 to about 9:1, or 6:1 to about 8:1.

In one embodiment, the weight percentage of reactive nanoparticles absent a fluorinated group, relative to the combined weight of all reactive particles and ethylenically unsaturated urethane fluorinated components, is from 20% to 90%, e.g. 40-90%, 60-90%, or 75-90%. In one embodiment, the weight percentage of reactive nanoparticles having a fluorinated group, relative to the combined total weight of all reactive particles and ethylenically unsaturated urethane fluorinated components, is 5-50%, e.g. 5-35%, 5-25%, or 10-15%.

Ethylenically Unsaturated Urethane Fluorinated Component:

In one embodiment, the ethylenically unsaturated urethane fluorinated component is a fluorinated oligomer comprising one or more ethylenically unsaturated groups and one or more urethane groups.

The fluorinated urethane oligomer may be the reaction product of at least a fluorinated polyol, a polyisocyanate and a reactive monomer containing ethylenic unsaturation. The reactive monomer may contain, e.g., (meth)acrylate, vinyl ether, maleate , fumarate or other ethylenically unsaturated group in its structure.

In one embodiment, the fluorinated urethane oligomer has a molecular weight in the range of about 700 to about 10,000 g/mol, for instance about 1000 to about 5000 g/mol.

The fluorinated polyols that may be used in the preparation of the fluorinated urethane oligomer include, e.g., fluorinated polymethylene oxide, polyethylene oxide, polypropylene oxide, polytetramethylene oxide or copolymers thereof. In one embodiment, the fluorinated polyols are endcapped with ethylene oxide. Suitable fluorinated polyols include for instance the Fluorolink fluids series of products (Fluorolink L,C,D,B,E,B1,T, L10, A10, D10, S10, C10, E10, T10, or F10) or Fomblin Z-Dol TX series of products, marketed by Solvay-Solexis Inc. These polyols are fluorinated poly(ethylene oxide-methylene oxide) copolymers endcapped with ethylene oxide). Other fluorinated polyols that may be suitable include acrylic oligomers or telechelomers with pendant or main-chain fluorinated functionality such as acrylic copolymers of hexafluoropropene and hydroxybutyl acrylate, or acrylic copolymers of trifluoroethyl (meth)acrylate and hydroxybutyl acrylate. Other suitable fluorinated polyols include polyols such as L-12075 marketed by 3M corporation and the MPD series of polyols marketed by Dupont.

Polyisocyanates that may be used in the preparation of the fluorinated urethane oligomer include a wide variety of organic polyisocyanates, alone or in admixture. The polyisocyanates may be be reacted with the fluorinated polyols and ethylenically unsaturated isocyanate reactive compounds to form the ethylenically unsaturated urethane fluorinated component: Diisocyanates are among the preferred polyisocyanates. Representative diisocyanates include isophorone diisocyanate (IPDI), toluene diisocyanate (TDI), diphenylmethylene diisocyanate, hexamethylene diisocyanate, cyclohexylene diisocyanate, methylene dicyclohexane diisocyanate, 2,2,4-trimethyl hexamethylene diisocyanate, m-phenylene diisocyanate, 4-chloro-1,3-phenylene diisocyanate, 4,440 -biphenylene diisocyante, 1,5-naphthylene diisocyanate, 1,4-tetramethylene diisocyanate 1,6-hexamethylene diisocyanate, 1,10-decamethylene diisocyanate, 1 ,4-cyclohexylene diisocyanate, and polyalkyloxide and polyester glycol diisocyanates such as polytetramethylene ether glycol terminated with TDI and polyethylene adipate terminated with TDI, respectively.

In one embodiment, the fluorinated polyol and polyisocynate are combined in a weight ratio of about 1.5:1 to about 7.5:1 fluorinated polyol to polyisocyanate. The fluorinated polyol and polyisocyanate may be reacted in the presence of a catalyst to facilitate the reaction. Catalysts for the urethane reaction, such as dibutyltin dilaurate and the like, are suitable for this purpose.

The isocyanate-terminated prepolymers may be endcapped by reaction with an isocyanate reactive functional monomer containing an ethylenically unsaturated functional group. The ethylenically unsaturated functional groups are preferably acrylates, vinyl ethers, maleates, fumarates or other similar compounds.

Suitable monomers that are useful to endcap the isocyanate terminated prepolymers with the desired (meth)acrylate functional groups include hydroxy functional acrylates such as 2-hydroxy ethyl acrylate, 2-hydroxy propyl acrylate and the like.

Suitable monomers which are useful to endcap the isocyanate terminated prepolymers with the desired vinyl ether functional groups include 4-hydroxybutyl vinyl ether, triethylene glycol monovinyl ether and 1,4-cyclohexane dimethylol monovinyl ether. Suitable monomers which are useful to endcap the prepolymers with the desired maleate functional group, include maleic acid and hydroxy functional maleates.

There is desirably a sufficient amount of isocyanate reactive functionality in the monomer containing acrylate, vinyl ether, maleate or other ethylenically unsaturated groups to react with any residual isocyanate functionality remaining in the prepolymer and endcap the prepolymer with the desired functional group. The term “endcap” means that a functional group caps each of the two ends of the prepolymer.

The isocyanate reactive ethylenically unsaturated monomer is reacted with the reaction product of the fluorinated polyol and the isocyanate. The reaction preferably takes place in the presence of an antioxidant such as butylated hydroxytoluene (BHT) and the like.

In one embodiment, the ethylenically unsaturated urethane fluorinated component has a viscosity, at 23° C., of at least 2500 centipoises (“cps”), e.g. at least 5000 cps, at least 7500 cps, at least 10,000 cps, at least 25,000 cps, or at least 50,000 cps. In one embodiment, the viscosity is at most 10,000,000 cps, for instance at most 5,000,000 cps or at most 1,000,000 cps.

In one embodiment, the percentage of ethylenically unsaturated urethane fluorinated components, relative to the combined weight of all reactive particles and ethylenically unsaturated urethane fluorinated components, is at least 0.75 wt %, e.g. at least 1 wt %, at least 2 wt %, at least 3 wt %, or at least 5 wt %. In one embodiment, the percentage of ethylenically unsaturated urethane fluorinated components, relative to the combined weight of all reactive particles and ethylenically unsaturated urethane fluorinated components, is at most 35 wt %, e.g. at most 25 wt %, at most 1 5 wt %, at most 10 wt %, or at most 8 wt %.

Diluent Monomers

In one embodiment, the present compositions comprise a diluent monomer, for instance to reduce the viscosity of the coating compositions. Examples of diluent monomers include polymerizable vinyl monomers such as polymerizable monofunctional vinyl monomers containing one polymerizable vinyl group in the molecule and polymerizable polyfunctional vinyl monomers containing two or more polymerizable vinyl groups in the molecule.

Examples of monofunctional diluent monomers include, e.g., monofunctional vinyl monomers such as N-vinyl pyrrolidone, N-vinyl caprolactam, vinyl pyridine; (meth)acrylates containing an alicyclic structure such as isobornyl (meth)acrylate or 4-butylcyclohexyl (meth)acrylate; 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, dodecyl (meth)acrylate, lauryl (meth)acrylate, stearyl (meth)acrylate.

Examples of polyfunctional diluent monomers include, e.g., trimethylolpropane tri(meth)acrylate, pentaerythritol tri(meth)acrylate, ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, trimethylolpropanetrioxyethyl (meth)acrylate, tris(2-hydroxyethyl)isocyanurate tri(meth)acrylate, tris(2-hydroxyethyl)isocyanurate di(meth)acrylate, and bis(hydroxymethyl)tricyclodecane di(meth)acrylate.

Diluent monomers may be halogenated, for instance fluorinated. Examples of fluorinated diluent monomers include, e.g., fluorinated acrylate monomers, for instance 2,2,3,3-tetrafluoropropyl acrylate, 1H,1H,5H-octafluoropentyl acrylate, or 1H,1H,2H,2H-heptadecafluorodecyl acrylate.

In one embodiment, the present coating composition comprises, relative to the combined weight of all reactive particles and ethylenically unsaturated urethane fluorinated components, 0-20 wt % of one or more diluents, e.g. 0.1-10 wt %, 0.25-5 wt %, or 0.5-2.5 wt %.

Additives:

Various additives such as antioxidants, UV absorbers, light stabilizers, adhesion promoters, coating surface improvers, heat polymerization inhibitors, leveling agents, surfactants, colorants, preservatives, plasticizers, lubricants, solvents, fillers, aging preventives, and wettability improvers ma be included in the present coating compositions. Examples of antioxidants include Irganox 1010,1035,1076, 1222 (manufactured by Ciba Specialty Chemicals Co., Ltd.), Antigene P, 3C, FR, Sumilizer GA-80 (manufactured by Sumitomo Chemical Industries Co., Ltd.), and the like; examples of UV absorbers include Tinuvin P, 234, 320, 326, 327, 328, 329, 213 (manufactured by Ciba Specialty Chemicals Co., Ltd.), Seesorb 102, 103, 110, 501, 202, 712, 704 (manufactured by Sypro Chemical Co., Ltd.), and the like; examples of light stabilizers include Tinuvin 292,144, 622LD (manufactured by Ciba Specialty Chemicals Co., Ltd.), Sanol LS770 (manufactured by Sankyo Co., Ltd.), Sumisorb TM-061 (manufactured by Sumitomo Chemical Industries Co., Ltd.), and the like; examples of silane coupling agents as adhesion promoters γ-mercaptopropylmethylmonomethoxysilane, γ-mercaptopropylmethyldimethoxysilane, γ-mercaptopropyltrimethoxysilane, γ-mercaptopropylmonoethoxysilane, γ-mercaptopropyidiethoxysilane, γ-mercaptopropyltriethoxysilane, β-mercaptoethylmonoethoxysilane, β-mercaptoethyltriethoxysilane, β-mercaptoethyltriethoxysilane, N-(2-aminoethyl)-3-aminopropylmethyidimethoxysilane, N-(2-aminoethyl)-3-aminopropyltrimethoxysilane, γ-aminopropyltriethoxysilane, γ-glycidoxylpropyltrimethoxysi lane, γ-glycidoxyl propylmethyldimethoxysilane, 2-(3,4-epoxycyclohexyl) ethyltrimethoxysilane, γ-chloropropylmethyldimethoxysilane, γ-chloropropyltrimethoxysilane, and γ-methacryloyloxypropyltrimethoxysilane. Examples of commercially available products of these compounds include SILAACE S310, S311, S320, S321, S330, S510, S520, S530, S610, S620, S710, S810 (manufactured by Chisso Corp.), Silquest A-174NT (manufactured by OSI Specialties—Crompton Corp.). SH6062, AY43-062, SH6020, SZ6023, SZ6030, SH6040, SH6076, SZ6083 (manufactured by Toray-Dow Corning Silicone Co., Ltd.), KBM403, KBM503, KBM602, KBM603, KBM803, KBE903 (manufactured by Shin-Etsu Silicone Co., Ltd.), and the like. Also acidic adhesion promoters such as acrylic acid may be used. Phosphate esters such as Eb168 or Eb170 from UCB are feasible adhesion promoters; Examples of coating surface improvers include silicone additives such as dimethylsiloxane polyether and commercially available products such as DC-57, DC-1 90 (manufactured by Dow-Corning), SH-28PA, SH-29PA, SH-30PA, SH-1 90 (manufactured by Toray-Dow Corning Silicone Co., Ltd.), KF351, KF352, KF353, KF354 (manufactured by Shin-Etsu Chemical Co., Ltd.), and L-700, L-7002, L-7500, FK-024-90 (manufactured by Nippon Unicar Co., Ltd.).

In one embodiment, the present compositions comprise, relative to the total weight of ethylenically unsaturated urethane fluorinated components, about 0.01 to about 10 weight percent of adhesion promoter. In one embodiment, the present compositions comprise, relative to the total weight of ethylenically unsaturated urethane fluorinated components, about 0.01 to about 5 weight percent based of antioxidant.

Photoinitiators include, e.g., hydroxy- or alkoxy-functional acetophenone derivatives, hydroxyalkyl phenyl ketones, and/or benzoyl diaryl phosphine oxides. Examples of photoinitiators include Irgacure 651 (benzildimethyl ketal or 2,2-dimethoxy-1,2-diphenylethanone, Ciba-Geigy), Irgacure 184 (1-hydroxy-cyclohexyl-phenyl ketone as the active component, Ciba-Geigy), Darocur 1173 (2-hydroxy-2-methyl-1-phenylpropan-1-one as the active component, Ciba-Geigy), Irgacure 907 (2-methyl-1-[4-(methylthio)phenyl]-2-morpholino propan-1-one, Ciba-Geigy), Irgacure 369 (2-benzyl-2-dimethylamino-1-(4-morpholinophenyl)-butan-1-one as the active component, Ciba-Geigy), Esacure KIP 150 (poly {2-hydroxy-2-methyl-1-[4-(1-methylvinyl)phenyl]propan-1-one}, Fratelli Lamberti), Esacure KIP 100 F (blend of poly {2-hydroxy-2-methyl-1-[4-(1 methylvinyl)phenyl]propan-1-one}and 2-hydroxy-2-methyl-1-phenyl-propan-1-one, Fratelli Lamberti), Esacure KTO 46 (blend of poly {2-hydroxy-2-methyl-1-[4-(1-methylvinyl)phenyl]propan-1-one}, 2,4,6-trimethylbenzoyidiphenylphosph ine oxide and methylbenzophenone derivatives, Fratelli Lamberti), Lucirin TPO (2,4,6-trimethylbenzoyl diphenyl phosphine oxide, BASF), Irgacure 819 (bis (2,4,6-trimethylbenzoyl)-phenyl-phosphine-oxide, Ciba-Geigy), Irgacure 1700 (25:75% blend of bis (2,6-dimethoxybenzoyl)2,4,4-trimethylpentyl phosphine oxide and 2-hydroxy-2-methyl-1-phenyl-propan-1-one, Ciba-Geigy), and the like.

Oligomers having the two different types of ethylenic unsaturation, i.e., the vinyl ether group and another ethylenically unsaturated group, may copolymerize rapidly in the presence of these photoinitiators to provide a rapid photocure and also interact rapidly upon exposure to other types of energy when no polymerization initiator is present.

In one embodiment, the photoinitiator is present in the present compositions, relative to the combined weight of all reactive particles and ethylenically unsaturated fluorinated urethane components, in an amount in the range of about 0.01 to about 20.0 weight percent, for instance, e.g. in an amount of about 1-1 5 wt %, 4-1 2 wt %, or 5-1 Owt %.

In one embodiment, the amount of photoinitiator is at least 2 weight percent based on the total weight of the coating composition, for instance at least 5 weight percent.

In one embodiment, the present invention relates to a radiation curable composition comprising:

50 wt % to 90 wt % of reactive nanoparticles free of fluorinated groups, relative to the combined weight of all reactive particles and ethylenically unsaturated urethane fluorinated components;

5 wt % to 20 wt % of reactive nanoparticles having at least one fluorinated group, relative to the combined weight of all reactive particles and ethylenically unsaturated urethane fluorinated components; and

1-10 wt % of one or more ethylenically unsaturated urethane fluorinated components, relative to the combined weight of all reactive particles and ethylenically unsaturated urethane fluorinated components.

In one embodiment, the present invention relates to a composition comprising:
a) reactive nanoparticles absent a fluorinated group; and
b) reactive nanoparticles having at least one fluorinated group;
ii) wherein the ratio of particles (a) to particles (b) is at least 1:1.

In one embodiment, the present invention relates to a composition comprising:
a) reactive nanoparticles absent a fluorinated group; and
b) reactive nanoparticles having at least one fluorinated group;
ii) wherein the ratio of particles (a) to particles (b) is less than 0.95:1.

In one embodiment, the present invention relates to a composition comprising:
reactive nanoparticles; and
one or more ethylenically unsaturated urethane fluorinated components;
   i) wherein the ratio of said reactive nanoparticles to said ethylenically unsaturated urethane fluorinated components is at least 6:1.
      Coatings and properties:

In one embodiment of the present invention, the composition is spin-coated on substrates using a standard Headway Research model EC101 DT spin coater. Then 1 ml of the liquid composition was deposited on stationary 3″×3″ substrates mounted on the spin-coater chuck platform. The applied liquid/substrate was then spin coated at 7500 rpm at a spin acceleration rate of 3000 rpm/s for 12 seconds. The resultant thin wet film after spin-coating was allowed to further evaporate at room temperature for 60 s. The evaporated thin film was subjected to a UV-dose of 2.0 J/cm² utilizing a Fusion D-lamp within an applied nitrogen atmosphere. The UV-dose was verified using an International Light model IL 390B Light Bug ultraviolet radiometer. Before application liquid coatings were diluted in solvent to 5% total solids resulting in cured film thickness, after application and cure, of 0.10-0.15 μm.

In one embodiment, the composition of the invention, when cured, provides a coating with low refractive index. In one embodiment, the coating has a refractive index of less than 1.50, e.g. in the range of 1.35-1.50, for instance 1.40-1.48, 1.42-1.46, or 1.432 to 1.50.

In one embodiment, the composition of the invention, when cured, provides a coating with good surface hardness and abrasion resistance. These are characterized by pencil test for film hardness and abrasion test. In one embodiment, the coating has a pencil hardness of at least F, for instance at least H or at least 2H. In one embodiment, the coating also has no damage when tested by abrasion test. These tests are set forth in the Examples portion.

The degree of cure of the composition can be indicated by the percentage of reacted acrylated saturation (% RAU). The test method of measuring % RAU is mentioned in the Example part of the description of invention. In one embodiment, the invention composition, when cured, has a % RAU of at least 40%, e.g. 45% to 90% or 55% to 70%.

The compositions in the present invention may be used as a low reflective index layer for an antireflective display system. The antireflective display system may comprise a substrate, a hardcoat layer on the substrate, a high refractive index layer applied on the hardcoat layer, following by a low refractive index layer.

Suitable substrates for display include organic substrates, e.g. plastic substrates such as substrates comprising polynorbornene, polyethyleneterephtalate, polymethylmethacrylate, polycarbonate, polyethersulphone, polyimide, cellulose, cellulose triacetate, fluorene polyester and/or polyethernaphtalene. Other examples of substrates include, e.g., inorganic substrates such as glass or ceramic substrates.

The substrates may be pre-treated prior to coating. For instance, the substrates may be subjected to corona or high energy treatment. The substrates may also be chemically treated, such as by emulsion application.

In one embodiment, the substrate comprises functional groups such as hydroxy groups, carboxylic acid groups and/or trialkoxysilane groups such as trimethoxysilane. The presence of such functional groups may improve adhesion of the coating to the substrate.

In one embodiment. the compositions of the present invention may also be used as an optical fiber primary coating, an optical fiber secondary coating, a matrix coating, a bundling material, an ink coating, a photonic crystal fiber coating, an adhesive for optical disc, a hardcoat coating, or a lens coating.

The present invention also relates to an article comprising:
(a) a substrate;
(b) a hardcoat layer;
(c) a high refractive index coating on said hardcoat layer; and
(d) a low refractive index coating, said low refractive index coating obtained by curing the composition comprising:
reactive nanoparticles free of fluorinated group reactive nanoparticles with fluorinated functionality;
reactive nanoparticles having at least one fluorinated group reactive nanoparticles without fluorinated functionality; and
an ethylenically unsaturated urethane fluorinated component.
   Process for Preparing a Low Refractive Index Coating:

The present invention also relates to a process for preparing a low refractive index coating, comprising mixing at least the following components:
reactive nanoparticles free of fluorinated group;
reactive nanoparticles having at least one fluorinated group; and
an ethylenically unsaturated urethane fluorinated component.

The present invention also relates to a process of making a coating for an article comprising:
b) preparing a radiation curable composition comprising:
reactive nanoparticles free of fluorinated group;
reactive nanoparticles having at least one fluorinated group; and
an ethylenically unsaturated urethane fluorinated component
ii) b) coating said radiation curable composition on said article.

### EXAMPLES

The following examples are given as particular embodiments of the invention and to demonstrate the practice and advantages thereof. It is to be understood that the examples are given by way of illustration and are not intended to limit the specification or the claims that follow in any manner.

Preparation of Composition I (Comprising Reactive Nanoparticles Absent a Fluorinated Group):

The components and their relative amounts used to prepare Composition I is shown in Table 1 below. Nanosilica oxide particles were surface-grafted by adding a trimethoxy-silane compound comprising an acrylate group (Int-12A) together with a compound that inhibits polymerization of the acrylate groups, HQMME, to a suspension of the nanosilica oxide particles in MEK (MEK-ST). A small amount of water is added to the MEK-ST suspension (1.7 w % of total MEK-ST) for catalysis of the silane grafting reaction. During stirring the mixture was refluxed for at least three hours at 60° C. Following this, an alkoxy silane compound, MTMS, was added and the resultant mixture was stirred and refluxed at 60° C. for at least one hour. A dehydrating agent, OFM, was added and the resultant mixture was stirred and refluxed at 60° C. for at least one hour.

TABLE 1
Materials (in weight percentage) used for the
preparation of Composition I: approximately
33 wt. % Reactive Nanoparticle Composition

| Material | Weight % |
|---|---|
| MEK-ST (nanosilica oxide particles in MEK [30 wt % of | 82.50% |
| solid particles relative to the combined weight of | |
| particles and methyl ethyl ketone]) | |
| Int-12A (trimethoxy silane acrylate coupling agent) | 7.84% |
| HQMME (Hydroquinone mono-methylether, stabilizer) | 0.14% |
| MTMS (Methyltrimethoxysilane, surface derivatizating agent) | 1.23% |
| OFM (Trimethyl orthoformate, dehydrating agent) | 8.29% |
| Total | 100% |

Preparation of Composition II (Comprising Reactive Nanoparticle Having at Least One Fluorinated Group):

The components and their relative amounts used to prepare fluorinated acrylated MT-ST is shown in Table 2 below. Nanosilica oxide particles were stabilized by adding a trimethoxy-silane compound comprising an acrylate group (Int-12A) together with a compound that inhibits polymerization of the acrylate groups, HQMME, to a suspension of the nanosilica oxide particles in Methanol (MT-ST). A small amount of water present in the MT-ST suspension (1.7 w % of total MT-ST) facilitated the silane grafting reaction. During stirring the mixture was refluxed for at least three hours at 60° C. Following this, a fluorinated alkoxy silane compound, TDFTEOS, was added and the resultant mixture was stirred and refluxed at 60° C. for at least one hour. Following this, an alkoxy silane compound, MTMS, was added and the resultant mixture was stirred and refluxed at 60° C. for at least one hour. A dehydrating agent, OFM, was added and the resultant mixture was stirred and refluxed at 60° C. for at least one hour.

TABLE 2
Materials (in weight percentage) used for the preparation
of Composition II: approximately 35% solids Fluorinated
Reactive Nanoparticles Composition

| Material | Weight % |
|---|---|
| MT-ST (Nanosilica particles in methanol [30 wt % of solid | 81.14% |
| particles relative to the combined weight of particles and | |
| methanol]) | |
| Int-12A (trimethoxy silane acrylate coupling agent) | 7.68% |
| HQMME (Hydroquinone mono-methylether, stabilizer) | 0.14% |
| TDFTEOS (Tridecafluoro-1,1,2,2-tetra- | 2.28% |
| hydrooctyl)triethoxysilane, surface derivativizing agent) | |
| MTMS (Methyltrimethoxysilane, surface derivativizing agent) | 0.61% |
| OFM (Trimethyl orthoformate, dehydrating agent) | 8.15% |
| Total | 100% |

Preparation of Ethylenically Unsaturated Urethane Fluorinated Component

An ethylenically unsaturated urethane fluorinated component was prepared by reacting the components in the following Table 3:

TABLE 3
Ethylenically Unsaturated Urethane Fluorinated Component

| Component | wt % |
|---|---|
| 2-Hydroxyethyl Acrylate | 8.18 |
| Isophorone Diisocyanate | 15.70 |
| BHT | 0.07 |
| Dibutyltin Dilaurate | 0.04 |
| Fluorolink E (fluorinated polyether) | 76.01 |

The thus prepared ethylenically unsaturated urethane fluorinated component (hereinafter also referred to as H-I-FluorolinkE-I-H) was mixed with the components in the following Table 4 to form Intermediate Composition A:

TABLE 4
Intermediate Composition A

| Component | Wt % |
|---|---|
| H-I-FluorolinkE-I-H | 80.7 |
| Lucirin TPO | 0.5 |
| Irgacure 184 | 1.5 |
| Irganox 1035 | 0.3 |
| Hexanediol diacrylate | 16.0 |
| Mercaptopropyl trimethoxy silane | 1.0 |

Finally, a “Composition III” was then prepared by admixing the components in the following Table 5:

TABLE 5
Composition III (comprising approximately 7 wt. % of the
Ethylenically Unsaturated Urethane Fluorinated Component)

| Component | wt % |
|---|---|
| Composition A | 8.8 |
| Darocur 1173 | 1.2 |
| Methyl Ethyl Ketone | 90.0 |

The compositions of Example 1 and Comparative Examples 1-10 were prepared by admixing the components in the following Table 6A (wt % are relative to the total weight of the composition). Test properties are set forth in Table 6B.

TABLE 6A
Example 1 and Comparative Examples 1-10:

| | | C. Ex. | C. Ex. | C. Ex. | C. Ex. | C. Ex. | C. Ex. | C. Ex. | C. Ex. | C. Ex. | C. Ex. |
|---|---|---|---|---|---|---|---|---|---|---|---|
| Ingredients | Ex. 1 | 1 | 2 | 3 | 4 | 5 | 6 | 7 | 8 | 9 | 10 |
| Composition I (≈33 wt. % Reactive | 68.0 | | 49.0 | 49.0 | 98.0 | | | | | 68.0 | 68.0 |
| Nanoparticle Composition) | | | | | | | | | | | |
| Composition III (comprising ≈7 wt. % | 20.0 | 49.0 | 49.0 | | | 98.0 | | | | | |
| fluorinated urethane acrylate oligomer) | | | | | | | | | | | |
| Composition II (≈35 wt. % Fluorinated | 10.0 | 49.0 | | 49.0 | | | 98.0 | | | 10.0 | 10.0 |
| Reactive Nanoparticle Composition) | | | | | | | | | | | |
| Tosoh TFEMA | | | | | | | | 98.0 | | | 2.0 |
| (Fluorinated mono-methacrylate monomer) | | | | | | | | | | | |
| NTX 5847 | | | | | | | | | 98.0 | 2.0 | |
| (Perfluorinated polyether diacrylate) | | | | | | | | | | | |
| Methyl Ethyl Ketone (solvent) | | | | | | | | | | 18.0 | 18.0 |
| Irgacure 184 | 1.5 | 1.5 | 1.5 | 1.5 | 1.5 | 1.5 | 1.5 | 1.5 | 1.5 | 1.5 | 1.5 |
| Irgacure 907 | 0.5 | 0.5 | 0.5 | 0.5 | 0.5 | 0.5 | 0.5 | 0.5 | 0.5 | 0.5 | 0.5 |

Tosoh TFEMA is commercially available from Tosoh.
NTX5847 is commercially available from Sartomer.
Irgacure 184 and Irgacure 907 are commercially available from Ciba.

TABLE 6B
Film properties after cure

| | | C. Ex. | C. Ex. | C. Ex. | C. Ex. | C. Ex. | C. Ex. | C. Ex. | C. Ex. | C. Ex. | C. Ex. |
|---|---|---|---|---|---|---|---|---|---|---|---|
| Properties | Ex. 1 | 1 | 2 | 3 | 4 | 5 | 6 | 7 | 8 | 9 | 10 |
| Cured film refractive index (RI) | 1.469 | 1.467 | 1.474 | 1.475 | 1.483 | 1.437 | 1.473 | 1.497 | 1.357 | 1.477 | 1.481 |
| Pencil Hardness | 2H | ≦4B | 2B | ≦4B | ≦4B | 4B | ≦4B | 2B | ≦4B | B | B |
| Abrasion test | 0 | 2 | 2 | 1 | 1 | 1 | 2 | 3 | 2 | 1 | 1 |
| % RAU | 68.1 | 71.2 | 66.1 | 51.1 | 44.9 | 100 | 39.9 | N/D | 0.1 | 50.7 | 56.3 |

Evaluation of Coating Properties (Test Methods):
Measurement of Film Hardness by Pencil Test (Pencil Hardness):

The pencil hardness was measured according to standard method ASTM D3363: The composition was cured on a glass substrate and the coated substrate is placed on a firm horizontal surface. The pencil is held firmly against the film at a 450 angle (point away from the operator) and pushed away from the operator in a 6.5 mm (1/4 in.) stroke. The process started with the hardest pencil and continued down the scale of hardness to either of two end points: one, the pencil that will not cut into or gouge the film (pencil hardness), or two, the pencil that will not scratch the film (scratch hardness)

The pencil hardness of the film is represented by the letters in the following list: (the film hardness increases from left to right):
4B, 3B, 2B, B, HB, F, H, 2H, 3H, 4H

If the hardness of the film is represented by any letter in the group of (F, H, 2H, 3H, 4H), the film is considered to be sufficiently hard.

Measurement of Cured film Refractive Index:

A glass microscope slide is coated with a test coating and the coating is cured by UV exposure. (Standard cure conditions: solvent evaporation, cure at 1.0 J/cm2, Fusion 300 W D-lamp, air atmosphere). 2mm×2mm squares are cut into the cured film using a razor blade. Alternating squares are removed from the cured film. The slide is then placed under 1 Ox microscope set up for collimated axial transmitted illumination, and fitted with objectives of up to at least 0.70 numerical aperture. Monochromatic illumination is used by placing narrow bandwidth interference filters in the path of the microscope's built-in illumination system. If provision is made for external illumination sources, a monochromator may also be used to provide a continuously variable source. The normal wavelength used is 589 nm or the Sodium D-line, from whence the designation of refractive index figures as “n”. The cured film is then compared to standard liquids of known refractive index (Cargill Index of Refraction Liquids, Standard Group available from McCrone Microscopy Inc.). Using the bottle applicator rod, apply a small drop of the refractive index liquid adjacent to the cover slip fragment so that capillary action carries it beneath the cover slip to fill the spaces around the coating squares. As the microscope focus is adjusted so that the distance between the sample and the objective increases, the Becke' line will move toward the medium of higher refractive index. If the coating has a higher refractive index than the liquid it is mounted in, the Becke' line will move into the outline of the squares as the focus is moved “up”. Repeat steps on fresh coating squares until the outline of the squares disappears or the Becke' line reverses direction from that observed from the previous observation. A higher or lower refractive index liquid is chosen depending on the direction of the refractive index mismatch indicated by the initial observation. If the outline of the coating squares fails to disappear and two liquids adjacent to one another in the set are found which give opposite signs of Becke' line movement, the refractive index of the material then lies between the two values, most likely centered in the range.

Abrasion Test:

A coated substrate is placed on a firm horizontal surface. A paper laboratory cleanup wipe (Kimwipes® EX-L available from Kimberly Clark Co.) is wrapped around a finger of tester' hand. Medium hand pressure is used to rub the paper over the cured film back and forth 2-3 times. The cured film is then examined for abrasive damage. The damage is then quantified by the following scale:
a) 0=No damage visible
b) 1=Slight damage visible
c) 2=Cured film is visibly damaged to a medium degree
d) 3=Cured film is completely removed or damaged

Damage by rubbing with the paper laboratory cleanup wipe indicates poor cured film hardness, and/or poor cured film crosslink density, and/or incomplete cure of photopolymerizable groups, and/or poor cured film adhesion to the substrate.

Determination of the Degree of Cure (% RAU) OF UV-Curable Coatings

A drop of the liquid coating is spin-coated on a KBr crystal until completely covered with approximately a 0.1 micron coating thickness. The sample is scanned using 100 co-added scans and spectrum is converted to absorbance. The net peak area of the acrylate absorbance of the liquid coating is then measured. For most acrylate-based coatings, the absorbance at 810 cm⁻¹ should be used. If the coating contains a silicone or other ingredient that absorbs strongly at or near 810 cm⁻¹, an alternative acrylate absorbance should be used.

The net peak area should be measured using the “baseline” technique in which a baseline is drawn tangent to absorbance minima on either side of the peak. The area under the peak and above the baseline is then determined.

The sample is cured with a 1.0 J/cm² using a 300 W Fusion D-lamp in an air atmosphere. The FTIR scan of the sample and the measurement of net peak absorbance for the spectrum of the cured coating are repeated. Baseline frequencies are not necessarily the same as those of the liquid coating, but should be chosen such that the baseline is still tangent to the absorbance minima on either side of the analytical band. The peak area measurement for a non-acrylate reference peak of both the liquid and cured coating spectrum is repeated. For each subsequent analysis of the same formulation, the same reference peak, with the same baseline points, should be utilized.

The ratio of the acrylate absorbance to the reference absorbance for the liquid coating is determined using the following equation:

$$a . {R}_{L} = \frac{{A}_{AL}}{{A}_{RL}}$$

iii) where A_{AL}=area of acrylate absorbance of liquid
   (a) A_{RL}=area of reference absorbance of liquid
   (b) R_{L}=area ratio of liquid

In a similar manner, the ratio of the acrylate absorbance to the reference absorbance for the cured coating is determined using the equation:

$$a . {R}_{F} = \frac{{A}_{AF}}{{A}_{RF}}$$

iv) where A_{AF}=area of acrylate absorbance of cured coating
   (a) A_{RF}=area of reference absorbance of cured coating
      a. RF=area ratio of cured coating

Finally, the degree of cure as percent-reacted acrylate unsaturation (% RAU) is calculated using the following equation:

$$\% RAU = \frac{( {R}_{L} - {R}_{F} ) \times 100}{{R}_{L}} \qquad ( b )$$

v) Where R_{L}=area ratio of liquid
   (a) R_{F}=area ratio of cured coating

For compositions containing an appreciable level of multifunctional acrylates are known to have relatively low % RAU values when fully cured, usually on the order of 55-70% RAU. This is thought to be due to vitrification of the acrylate network leading to the inability of unreacted acrylates to have sufficient mobility within the network to find a propagating free radical, and vice-versa.

Having described specific embodiments of the present invention, it will be understood that many modifications thereof will readily appear or may be suggested to those skilled in the art, and it is intended therefore that this invention is limited only by the spirit and scope of the following claims.

What is claimed is:

1. A radiation curable composition, comprising:
a) reactive nanoparticles absent a fluorinated group;
b) reactive nanoparticles having at least one fluorinated group; and
c) one or more ethylenically unsaturated urethane fluorinated components.

2. The composition according to claim 1, wherein both said reactive nanoparticles comprise metal oxide.

3. The radiation curable composition according to claim 2, wherein said reactive nanoparticles having at least one fluorinated group comprise an organic component bound to said metal oxide.

4. The radiation curable composition according to claim 3, wherein said organic component comprises unsaturated polymerizable group.

5. The composition according to claim 4, wherein said unsaturated polymerizable group is acrylate, methacrylate, propenyl, vinyl, butadienyl, styryl, ethynyl, cinnamoyl, vinyl ether, maleate, acrylamide, epoxy, oxetane, amine-ene or thiol-ene.

6. The radiation curable composition according to claim 4, wherein said fluorinated group is located in the organic component comprising unsaturated polymerizable group.

7. The radiation curable composition according to claim 4, wherein said fluorinated group is not located in the organic component comprising unsaturated polymerizable group.

8. The composition according to claim 1, wherein both said reactive nanoparticles comprise oxide of silicon.

9. The composition according to claim 1, wherein the ratio of said reactive nanoparticles absent a fluorinated group to said reactive nanoparticles having at least one fluorinated group is 1:9 to 9:1.

10. The composition according to claim 1, wherein said fluorinated group of said reactive particles is a fluoroalkyl group.

11. The composition according to claim 1, wherein said composition, when cured, has a refractive index of less than 1.50.

12. The composition according to claim 1, wherein said composition, when cured, has a pencil hardness no lower than F.

13. The composition according to claim 1, wherein said composition has a % RAU of at least 40%.

14. The composition according to claim 1, wherein said composition, when cured, when tested by abrasion test displays no damage.

15. A radiation curable composition, comprising:
a) 50 wt % to 90 wt % of reactive nanoparticles free of fluorinated group, relative to the total weight of said components (a), (b), and (c);
b) 5 wt % to 20 wt % of reactive nanoparticles having at least one fluorinated group, relative to the total weight of said components (a), (b), and (c); and
c) 1 wt % to 10 wt % of one or more ethylenically unsaturated urethane fluorinated components, relative to the total weight of said components (a), (b), and (c).

16. A radiation curable composition comprising:
a) reactive nanoparticles free of fluorinated group;
b) reactive nanoparticles having at least one fluorinated group;
c) ethylenically unsaturated urethane fluorinated component; and
d) one or more photoinitiators, wherein said composition has a RI lower than 1.50, a pencil hardness higher than F when cured, and a % RAU of 55% to 70%.

17. A radiation curable composition comprising:
a) reactive nanoparticles comprising an organic component bound to said reactive particles, wherein said organic component comprises an unsaturated polymerizable group and a fluorinated group in its structure; and
b) an ethylenically unsaturated urethane fluorinated component.

18. The radiation curable composition according to claim 17, wherein said reactive particles further comprise an organic component absent a fluorinated group.

19. The composition according claim 17, wherein said composition is formulated to provide, after cure, an optical fiber primary coating, an optical fiber secondary coating, a matrix coating, a bundling material, an ink coating a photonics crystal fiber coating, an adhesive for optical disc, a hard coat coating, a display coating or a lens coating.

20. A process for preparing a low refractive index coating, comprising:
a) reactive nanoparticles absent a fluorinated group;
b) reactive nanoparticles having at least one fluorinated group; and
c) an ethylenically unsaturated urethane fluorinated component.

21. A process for preparing an article with a low refractive index coating comprising: applying the composition according to claim 1 to a surface of a coated substrate.

22. A process of making a coating for an article comprising:
a) preparing a radiation curable composition comprising:
i) reactive nanoparticles absent a fluorinated group;
ii) reactive nanoparticles having at least one fluorinated group; and
iii) an ethylenically unsaturated urethane fluorinated component; and
b) coating said radiation curable composition on said article.

23. The process according to claim 22, wherein said article is an optical fiber, a photonics crystal fiber, an optical disc, an optical fiber ribbon, a hardcoat layer, an antireflective layer for display or lens.

24. A low refractive index coating prepared by curing a radiation curable composition according to claim 1.

25. A display monitor comprising a plastic substrate coated at least in part with a coating obtained by curing the composition according to claim 1.

26. An antireflective system comprising a coating obtained by curing the composition of claim 1.

27. An article comprising:
a) a substrate;
b) a hardcoat layer;
c) a high refractive index coating on said hardcoat layer; and
d) a low refractive index coating, said low refractive index coating obtained by curing the composition comprising:
i) reactive nanoparticles free of fluorinated group;
ii) reactive nanoparticles having at least one fluorinated group; and
iii) an ethylenically unsaturated urethane fluorinated component.

28. The article according to claim 27, wherein said article is an antireflective display.

29. The article according to claim 28, wherein said substrate is polynorbonene, polyethyleneterephtalate, polymethylmethacrylate, polycarbonate, polyethersulphone, polyimide, cellulose, cellulose triacetate, fluorene polyester or polyethernaphtalene.

30. A composition comprising:
a) reactive nanoparticles absent a fluorinated group; and
b) reactive nanoparticles having at least one fluorinated group;
wherein the ratio of particles (a) to particles (b) is at least 1:1.

31. A radiation curable composition, comprising:
a) reactive nanoparticles; and
b) one or more ethylenically unsaturated urethane fluorinated components;
wherein the ratio of said reactive nanoparticles to said ethylenically unsaturated urethane fluorinated components is at least 6:1.

32. A radiation curable composition wherein said composition, when cured, has
a) a refractive index of less than 1.5; and
b) a pencil hardness no lower than F.

33. The radiation curable composition of claim 32, wherein said composition, when cured has a % RAU of at least 40.

34. A display panel comprising a radiation curable coating composition wherein said composition, when cured, has
a) a refractive index of less than 1.5; and
b) a pencil hardness no lower than F.
